(19) United States
(12) Patent Application Publication
(10) Pub. No.: US 2008/0143018 A1
(43) Pub. Date: Jun. 19, 2008

(54) PROCESS FOR THE PREPARATION OF A POURED COSMETIC PRODUCT WITH A SUPERFICIAL RELIEF

(75) Inventor: MARCO LAZZARINI, Milan (IT)

Correspondence Address: AKERMAN SENTERFITT, P.O. BOX 3188, WEST PALM BEACH, FL, 33402-3188, US

(73) Assignee: INTERCOS S.P.A., Milan (IT)

(21) Appl. No.: 12/040,078

(22) Filed: Feb. 29, 2008

Related U.S. Application Data
(63) Continuation of application No. 10/991,049, filed on Nov. 17, 2004, now abandoned.

(30) Foreign Application Priority Data
Mar. 2, 2007 (IT) MI2007A000424

(51) Int. Cl. B29C 45/14

(52) U.S. Cl. 264/259

(57) ABSTRACT

There is disclosed a process for the preparation of a poured cosmetic product with a superficial relief. There are provided a first step of dosing a liquid state mixture of said cosmetic product within a shaped mould, a second step of solidifying the mixture within the mould, a third step of extracting the cosmetic product from the mould by exerting perpendicular forces on the bottom surface of the cosmetic product, a fourth step of overturning the cosmetic product within a final container.

The present invention relates to a process for the preparation of a poured cosmetic product with a superficial relief.

The term “poured cosmetic product” indicates a product formed by a mixture which is taken to the melting temperature so as to change from a solid state to a liquid state and to allow its dosed introduction by “pouring” within appropriate moulds, where it subsequently solidifies in order to form a solid tablet of different shapes and sizes, which is finally extracted from the mould and overturned in the final container.

Cosmetic products obtained in this manner have a lower surface, which will hereafter be designated as “bottom surface”, and an upper surface, which will hereafter be designated as “decorative surface”, which may either be smooth or have reliefs.

Currently, for the production of a poured cosmetic product with superficial reliefs, a mould is used featuring a shaping complementary to the reliefs of the decorative surface of the cosmetic product. A thick grid having protruding edges with respect to the edges of the mould is applied internally at the mouth of the mould.

While the cosmetic product is produced, the mould is initially filled, through the grid, with a molten mixture of cosmetic product, until the level of the edge of the grid is reached.

During the following solidification, the mixture becomes integral with the grid thus forming the cosmetic product, temporarily placed in an inverted position: the bottom surface is in an overlaid position protruding from the edge of the grid, and the decorative surface is in an underlaid position enclosed within the mould.

The cosmetic product is at last placed in the final container by using handling equipment, which clamps the edges, raises, overtures and introduces the grid with the corresponding cosmetic product within the final container.

In this manner, the grid becomes a part of the marketed product, with a subsequent additional cost and a waist of space and weight; moreover, much of the cosmetic product remains unused, trapped in the interstices of the grid.

It is the object of the present invention to overcome the above mentioned drawbacks.

According to the invention, such an object is achieved by a process for the preparation of a poured cosmetic product, said cosmetic product comprising a decorative surface comprising reliefs and an essentially flat bottom surface, characterised in that it comprises a first step of dosing a liquid mixture of said cosmetic product within a shaped mould, a second step of solidifying said mixture within said mould in order to form said cosmetic product, a third step of extracting said cosmetic product from said mould by exerting perpendicular forces on said bottom surface, a fourth step of overturning said cosmetic product within a final container.

The extraction means may be sucking means, adhesion means or other means depending on the embodiment.

The surface on which the extraction forces are exerted may be formed by the bottom surface of the product itself, or by the outer surface of a small plate provided with holes or of a small cup also provided with holes, or by a wax layer on the bottom surface of the solidified cosmetic product.

The use of a traditional grid and the corresponding drawbacks may be avoided in virtue of the forces applied perpendicularly to the support surface providing a wide application area.

These and other features of the present invention will become more apparent from the following detailed description of embodiments thereof, shown by way of no limitation in the accompanying drawings, in which:

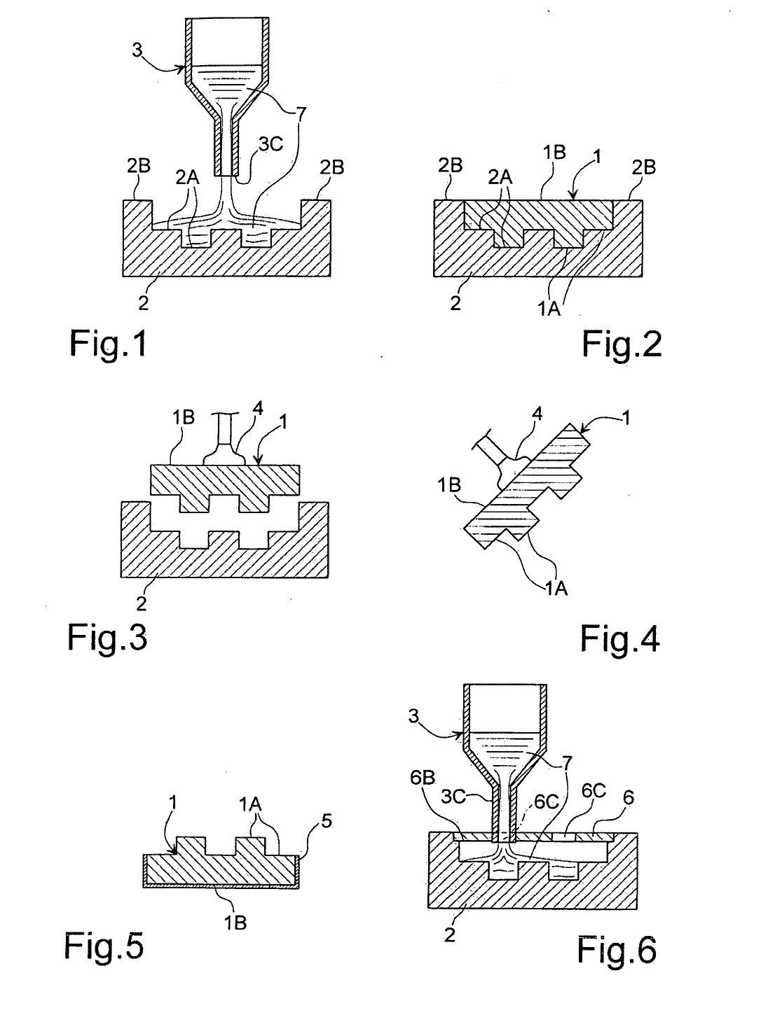

FIG. 1 shows the first step of a first embodiment of the process according to the invention;

FIG. 2 shows the second step of the process started in FIG. 1;

FIG. 3 shows the third step of the process started in FIG. 1;

FIG. 4 shows the fourth step of the process started in FIG. 1;

FIG. 5 shows the cosmetic product obtained at the end of the process started in FIG. 1.;

FIG. 6 shows the first step of a second embodiment of the process according to the invention;

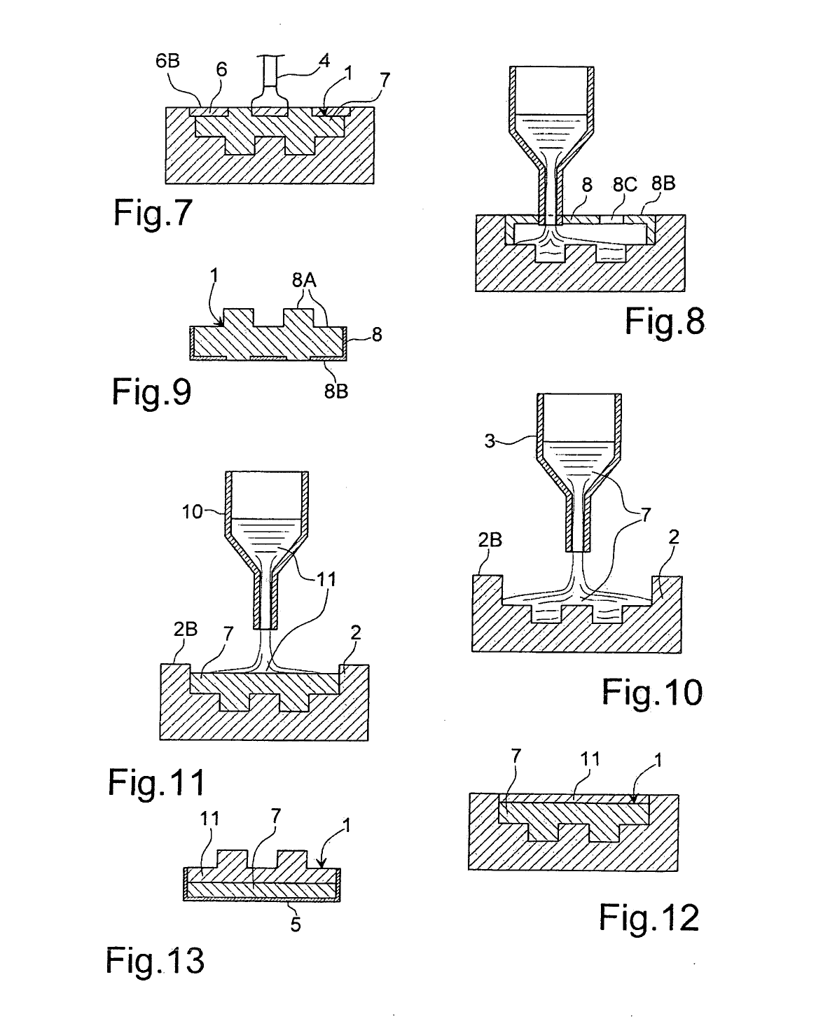

FIG. 7 shows the third step of the process started in FIG. 6;

FIG. 8 shows the first step of a third embodiment of the process according to the invention;

FIG. 9 shows a cosmetic product obtained by means of a process. according to the third embodiment;

FIG. 10 shows the first step of a fourth embodiment of the process according to the invention;

FIG. 11 shows a further step of the process started in FIG. 10;

FIG. 12 shows a further step of the process started in FIG. 10;

FIG. 13 shows the cosmetic product obtained at the end of the process started in FIG. 10.

FIG. 1 shows the first step of the first embodiment disclosed. A liquid mixture 7 which is formed by waxes, fats, oils and pigments is poured within a mould 2 with a shaped inner bottom 2A and side edges 2B. The dosing takes place at a high temperature and by force of gravity through a nozzle 3C of a mobile doser 3, placed above the mould 2.

FIG. 2 shows the second step of the process, in which the mixture solidifies at an ambient temperature, giving rise to the cosmetic product 1, in an inverted position with respect to the final position in which it will be marketed. It consists of a tablet having two surfaces 1A and 1B:
the bottom surface 1B is in a temporarily overlaid position; it is flat, smooth and horizontal;
the decorative surface 1A is in a temporarily underlaid position; it displays parts in relief which are complementary to the shaping 2A of the mould 2.

FIG. 3 shows the third step of the process. A mobile sucker 4 is applied to the support surface 1B of the cosmetic product 1.

The sucker applies a vertical force, perpendicular to the bottom surface 1B which is flat and smooth, has a relatively large size and easily allows the grip by the sucker 4, which easily extracts the cosmetic product 1.

FIG. 4 shows the, fourth step of the process, during which the mobile sucker 4 rotates by 180°, so as to take the bottom surface 1B in an underlaid position and the decorative surface 1A in an overlaid position.

There is provided the introduction of the cosmetic product 1 within a final container 5 to which it is adhered by sticking or by contact with a heat source.

At the end of the process, the cosmetic product 1 is arranged within the final container 5 with the overhanging decorative surface 1A and the support surface 1B.

A second embodiment is partially shown in FIGS. 6 and 7.

FIG. 6 shows the first step according to this second embodiment. It should be noted that the use of a small perforated plate 6 placed as a lid of the mould 2 is provided. The nozzle 3C of the doser 3 is placed at a hole 6C of the small plate 6 in order to introduce the mixture 7 in the mould 2.

The mixture 7 solidifies during the second step (not shown) and adheres to the small plate 6 so as to become integral therewith.

The following steps are the same as those in the first embodiment. It should be noted that the small plate 6 represents an ideal support for the sticking to the final container 5, as it is rigid.

A third embodiment of the present invention, shown in. FIGS. 8. and 9, features the use of a small perforated cup 8. The small cup 8 also represents the final container of the cosmetic product 1, thus further simplifying the process.

A fourth embodiment, shown in FIGS. 10-13, allows the interposition of a sixth intermediate step between the second and third step of the process shown in FIGS. 1-5.

During the first step (FIG. 10) the mixture 7 is introduced within the mould 2 so that the amount of mixture 7 does not reach the edge 2B of the mould 2. This mixture 7 is left to solidify during the second step.

At the end of this second step, a mixture of synthetic waxes 11 is overlaid to the solidified mixture 7 (FIG. 11) by means of a second doser 10, until the edge 2B of the mould 2 is reached. When the mixture of synthetic waxes 11 has also solidified (which occurs in a short time), the cosmetic product 1, still overturned, is a single piece with a layer of wax 11 which may adhere to a mobile means capable of extracting this cosmetic product 1 (FIG. 12) and of placing it within the final container 5 (FIG. 13).

At the end of this process, the cosmetic product 1 is introduced and fixed within the final container 5.

In all of the embodiments the mould 2 may be made of silicone, metal or different material.

Finally, a composite cosmetic product may also be produced by the juxtaposition of a tablet according to the invention with a similar tablet having a different composition or with a different tablet.

1. A process-for the preparation of a poured cosmetic product, said cosmetic product comprising a decorative surface comprising reliefs and an essentially flat bottom surface, characterised in that it comprises a first step of dosing a liquid mixture of said cosmetic product within a shaped mould, a second step of solidifying said mixture within said mould in order to form said cosmetic product, a third step of extracting said cosmetic product from said mould by exerting perpendicular forces on said bottom surface, a fourth step of overturning said cosmetic product within a final container.

2. A process according to claim 1, characterised in that said first step includes the injection of mixture in said mould through holes of a small plate placed as a lid of said mould, said mixture being capable of adhering to said small plate so as to form a single piece therewith.

3. A process according to claim 1, characterised in that said first step includes the injection of mixture in said mould through holes of a small cup placed as a lid of said mould, said mixture being capable of adhering to said small cup so as to form a single piece therewith.

4. A process according to claim 3, characterised in that said small cup is the final container of said cosmetic product.

5. A process according to claim 4, characterised in that it includes the dosing of said mixture within said mould so that the amount of said mixture does not reach the edge of said mould, and the dosed introduction between said second step and said third step of a mixture of synthetic waxes until the edge of said mould is reached, and the following solidification of said mixture of synthetic waxes.

6. A process according to claim 1, characterised in that said mould is made of silicone material.

7. A process according to claim 1, characterised in that said cosmetic product is adhered to said final container by means of a heat source.
